(19) United States
(12) Patent Application Publication
(10) Pub. No.: US 2024/0239394 A1
(43) Pub. Date: Jul. 18, 2024

(54) Zero Turn Radius Concrete Buggy

(71) Applicant: Allen Engineering Corporation, Paragould, AR (US)

(72) Inventors: Edward Andrew Waldon, Paragould, AR (US); Michael W. McKean, Arlington, TN (US)

(73) Assignee: Allen Engineering Corporation, Paragould, AR (US)

(21) Appl. No.: 18/415,229

(22) Filed: Jan. 17, 2024

Related U.S. Application Data
(60) Provisional application No. 63/439,676, filed on Jan. 18, 2023.

(51) Int. Cl. B62B 5/00

(52) U.S. Cl. CPC B62B 5/0026; B62B 2301/25

(57) ABSTRACT

A “zero turn radius” batch cart for delivering loads of raw concrete mix over difficult and uneven construction job sites transports a tiltable, load-receptive hopper displaceable between load bearing and load discharging positions. The rigid chassis is supported by front, hydraulically powered drive wheel assemblies and a pair of rear caster wheels for steering effects. An internal combustion engine, with its own throttle control, drives a hydraulic pump that powers separate hydraulic motors and valves for operating the cart. The front-mounted drive wheel assemblies are independently, hydraulically driven and each can be rotated forwardly or rearwardly independently of the other. Quick and precise zero-turn radius steering movements will result when the front wheel assemblies rotate in different directions, in combination with the caster rear wheel assemblies that exhibit negative caster.

### CROSS REFERENCE TO PRIOR APPLICATION

This utility conversion patent application is based upon previously filed and copending U. S. Provisional patent application entitled “Zero Turn Radius Concrete Buggy,” by coinventors Edward A. Waldon of Paragould, Arkansas and Michael W. Mckean of Arlington, Tennessee (both American Citizens), Ser. No. 63/439,676, filed Jan. 18, 2023, from which priority is claimed.

### BACKGROUND OF THE INVENTION

### 1. Field of the Invention

This invention relates generally to wheeled vehicles exhibiting zero radius turn capabilities. More particularly, the present invention relates to self-propelled carts, buggies and wagons used for hauling small batches of concrete that are often used in tight spaces where it is difficult to turn or maneuver.

### 2. Description of the Prior Art

Many relatively small vehicles and carts are used to transport moderate to heavy loads between workstations in typical manufacturing environments. In the concrete industry and trades, for example, small carts or wagons are often employed to move multiple, limited batches of concrete mix to a pour site from a concrete delivery truck This type of cart or wagon is needed because large and heavy concrete mixer trucks cannot access the work site in many job locations, because of restricted access and narrow or obstructed pathways. Thus, several small batches of concrete must be transported by carts or wagons to the pour site.

However, the ground around most construction sites is irregular and unlevel. Access passageways are often riddled with potholes, puddles and other obstacles. Typical job sites can be strewn with rocks and debris, and the trail leading to the pour site may be sloped and otherwise haphazardly defined. The danger is aggravated by the fact that the irregular pathways leading to the pour site require substantial steering efforts, and too much deflection of the steered wheels can aggravate the propensity for tipping. Moreover, the pour site is likely to be cramped and relatively small. Relatively compact concrete carts or wagons may have the appropriate dimensional clearance to address the pour site, but there is often insufficient room for conventional steering. Even on flat concrete surfaces stability can be a problem. When carts are loaded irregularly with heavy loads, imbalance may cause tilting and even tipping over. Moreover, shifting loads that occur suddenly can destabilize conventional carts and buggies, especially those with an overly broad steering radius. Furthermore, centrifugal forces developed with conventional buggies at excessive steering speeds can cause loss of balance, possibly throwing the driver from the operator's platform.

Accordingly, there is a need in the construction arts for an improved concrete delivery vehicle capable of enhanced, zero-radius turns. Stated another way, there is a need for a reliable and simple concrete batch delivery system adapted for difficult, hard-to-reach pour sites that have limited maneuvering space.

Some prior art carts or buggies using conventional steering systems need speed control devices for safety. Some sense steering angles or wheel deflection.

U.S. Pat. No. 6,491,122 issued Dec. 10, 2002, shows an electronic speed control for vehicles. A propulsion system is switchable between two modes, one of which allows a higher maximum speed than the other. A steering angle sensor and a tilt switch prevent the user from selecting the high-speed mode while steering sharply or while going down or across steep slopes.

U.S. Pat. No. 6,170,584 issued Jan. 9, 2001, illustrates a speed control system for a tracked vehicle having an engine-driven hydraulic steering pump which drives a hydraulic steering motor. The steering pump is responsive to an operator manipulated steering wheel. The steering motor provides an input to a differential track drive mechanism which responds to manipulation of the steering wheel and drives left and right tracks to turn the vehicle. A control unit calculates a motor speed threshold value as a function of sensed engine speed and steering control signals and generates a fault signal as a function of a relationship between the steering motor speed signal and a motor speed threshold value. The fault signal may be processed to safely limit speed.

U. S. Pat. Application No. 20040158375 published Aug. 12, 2004, discloses a motion control apparatus for automotive vehicles that limits speed by monitoring the vehicle steering angle.

U. S. Pat. Application No. 20060260859 published Nov. 23, 2006, discloses a drive speed control system for vehicles with rear wheel drive and steerable front wheels. A control unit ensures that a front/rear wheel speed ratio is a linear trigonometric function of a sensed steering angle signal. Speed is thus relative to the sensed steering angle.

U. S. Pat. Application No. 20090138168 published May 28, 2009, discloses a method for operating a cruise control system that identifies certain low speed environments, like parking lots, where usage of the cruise control system is usually inappropriate. The method compares a sensed steering wheel position to a steering wheel threshold to determine if the vehicle is operating in an inappropriate, low speed environment and, if so, disables the cruise control system accordingly.

U.S. Pat. application No. 20120136539 published May 31, 2012, illustrates an electronically controlled, speed limiting system for turf maintenance machines. In this device a hydraulic pump operating a traction motor has its output varied by an actuator that is connected to a controller. The controller monitors a wheel speed sensor. A brake is activated by the controller if the wheel speed sensor detects wheel slipping or spinning. A steering position sensor signal is used by the controller to modify brake activation during machine turns.

U.S. Pat. No. 7,108,096 issued Sep. 19, 2006, discloses a control system for use with a self-propelled, steerable vehicle, such as a lawn mower or the like which limits speed by interconnection with a steering system. The system slows vehicle speed when turns are made beyond a predetermined range and the speed equals or exceeds a predetermined level, as determined by a speed control device connected to a speed control linkage. This slowing results in increased traction for achieving tighter turns, and it also improves dynamic stability. Two different types of rack-and-pinion steering systems capable of being used with the control system are illustrated.

A prior art Allen Engineering Corporation concrete buggy is described in pending U.S. patent application Ser. No. 17/152,218, filed Jan. 19, 2021, and entitled “Electric Concrete Transportation Cart,” the contents and disclosure of which is hereby incorporated by reference. The latter Allen cart is seen in publication US2021/0229664. It comprises a cargo bucket or hopper that is tiltable over front drive wheels for transporting and dumping cargo. Hydraulic drive motors driven by a hydraulic pump propel rear wheels at a selectable speed. Steering handlebars rotate a steering column that turns the rear wheels. A throttle cable extending from the handlebars controls the throttle setting by pivoting a throttle lever mounted on the hydraulic pump. Limiting linkages extend from flanges on an anchor bracket secured to the steering column to a bridge on the throttle lever. As the steering column rotates, the limit linkages are wound partially about it, pivoting the throttle lever by pulling on the bridge, reducing pump speed. Heavy steering displacements will retract the throttle lever to reduce cart speed notwithstanding the previous speed setting chosen by the operator via the cable.

Another prior art concrete batch cart sold by Allen Engineering Corporation is described in publication US2018/0346007. The latter cart exhibits improved steering characteristics.

Finally, an Allen Engineering Corporation cart sold under the under model number AT16 includes a tracked drive system, like bulldozers and the like, and it exhibits certain zero-turn radius characteristics.

Whether or not a cart is conventionally or electrically powered, there exists a demand for a highly maneuverable cart or buggy characterized by zero turn radius steering. Such a cart or buggy may avoid potential spills or turnovers that have hitherto been encountered in cramped and hostile, irregular construction environments.

### SUMMARY OF THE INVENTION

This invention comprises a wheeled, self-propelled, “zero turn radius” batch cart for delivering loads of materials or supplies, such as raw concrete mix, to otherwise hard-to-reach places at a construction job site.

The cart comprises a rigid chassis supported by front-mounted drive wheels for propulsion and maneuvering, and a pair of rear caster wheels for steering. A conventional internal combustion engine, with its own throttle control, drives at least one hydraulic pump that powers separate hydraulic motors and valves for operating the cart. A cargo bucket pivotally mounted over the chassis front can be hydraulically displaced between a rest or load position and a tilted, load discharge position.

A pair of front-mounted propulsion wheel assemblies are independently, hydraulically driven, so that one may be reversed relative to the other for extreme “zero turn” maneuvering. Support at the rear of the cart is established by spaced apart caster wheel assemblies that exhibit negative caster. A tiltable, load-receptive hopper disposed over the drive wheels at the front of the cart can be moved between load bearing and load discharging positions by hydraulic actuators. Each drive wheel assembly can be driven forwardly or rearwardly independently of the other to effectuate cart steering, in cooperation with the rear caster wheels that readily revolve around a substantially vertical axis for significant maneuvering.

Thus a basic object of the invention is to provide a wheeled, self-propelled, “zero turn” buggy or cart that safely and reliably makes extreme turns within limited space.

Another fundamental object is to provide a concrete batch delivery cart or buggy that is ideal for maneuvering through and within cramped and difficult spaces or locations.

stable and safe.

Another basic object is to enhance the steering characteristics of a concrete batch cart or buggy.

A related object is to provide a buggy or cart of the character described that remains stable during sharp turns, even when heavily loaded.

Another object is to provide such a cart that can safely maneuver over rough and irregular terrain that is characteristic of typical construction sites.

Yet another object is to provide a self-propelled buggy or cart of the character described that can safely traverse sloped, irregular pathways strewn with debris and obstacles.

These and other objects and advantages will appear or become apparent in the course of the following descriptive sections.

### BRIEF DESCRIPTION OF THE DRAWINGS

In the accompanying drawings, which form a part of the specification, and which are to be construed in conjunction therewith, and wherein like reference numerals have been employed where reasonably possible to indicate like parts in the various views:

FIG. 1 is a right frontal isometric view of a zero-turn radius batching cart constructed in accordance with the best mode of the invention, showing it deployed within a construction zone;

FIG. 2 is a left frontal isometric view of the cart;

FIG. 3 is a right rear isometric view thereof;

FIG. 4 is a left rear isometric view thereof;

FIG. 5 is a right side elevational view thereof;

FIG. 6 is a left side elevational view thereof;

FIG. 7 is a front plan view thereof;

FIG. 8 is a rear plan view thereof;

FIG. 9 is an enlarged, fragmentary left isometric view thereof;

FIG. 10 is an enlarged, fragmentary isometric view of a preferred embodiment, showing the motor, and the linkage apparatus within the control console;

FIG. 11 is an enlarged, partially exploded diagrammatic view showing control console linkages, the drive motor, the hydraulic drive pumps, and auxiliary pumps;

FIG. 12 is an enlarged, exploded view of a preferred caster wheel assembly; and,

FIG. 13 is a hydraulic schematic diagram.

### DETAILED DESCRIPTION OF THE SEVERAL VIEWS OF THE DRAWINGS

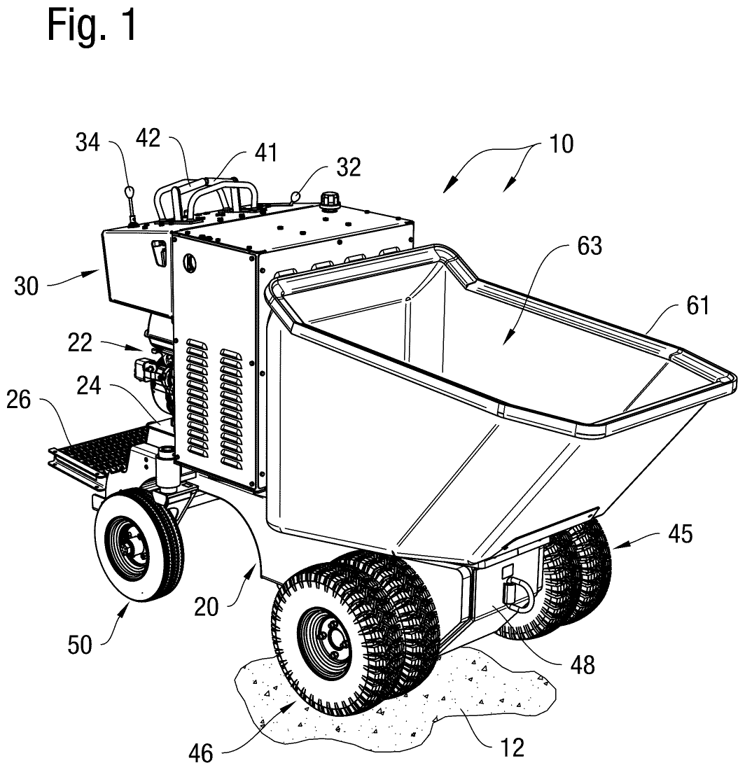

With initial reference now directed to FIGS. 1-9 of the appended drawings, a zero-turn radius cart or buggy constructed in accordance with the best mode of the invention has been generally designated by the reference numeral 10. (For purposes of the disclosure the terms “cart” and/or “buggy” are used interchangeably.) The self-propelled, steerable cart 10 is adapted to be deployed within a construction zone over a work site surface 12 (FIG. 1), for moving materials or supplies or tools to and from the work site. The cart 10 is especially adapted for hauling and delivering small batches of liquid concrete to areas that cannot be safely or comfortably reached by much larger and heavier concrete mixing trucks. The work site surface 12 is typically unlevel, and the pathway leading to surface 12 is often sloped and rough, possibly with debris scattered about. Thus cart 10 must be stable when heavily loaded, and it must be able to safely accommodate typical irregular and unlevel pathways while moving heavy loads. Additionally, surface 12 and the path leading to it may be small and cramped, complicating cart maneuvering. Because of this typical work environment, the cart 10 must be highly maneuverable, and a zero-turn radius steering system described below is employed.

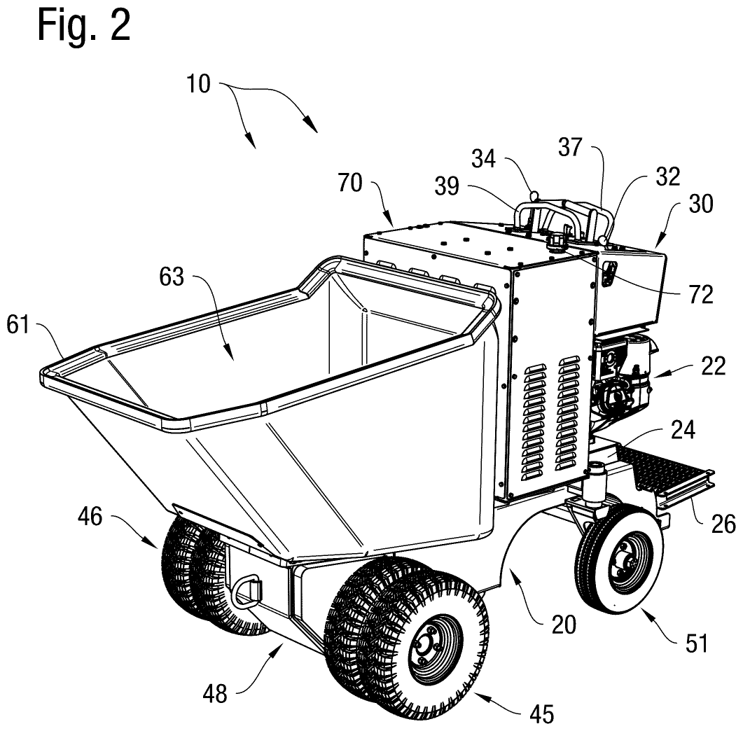

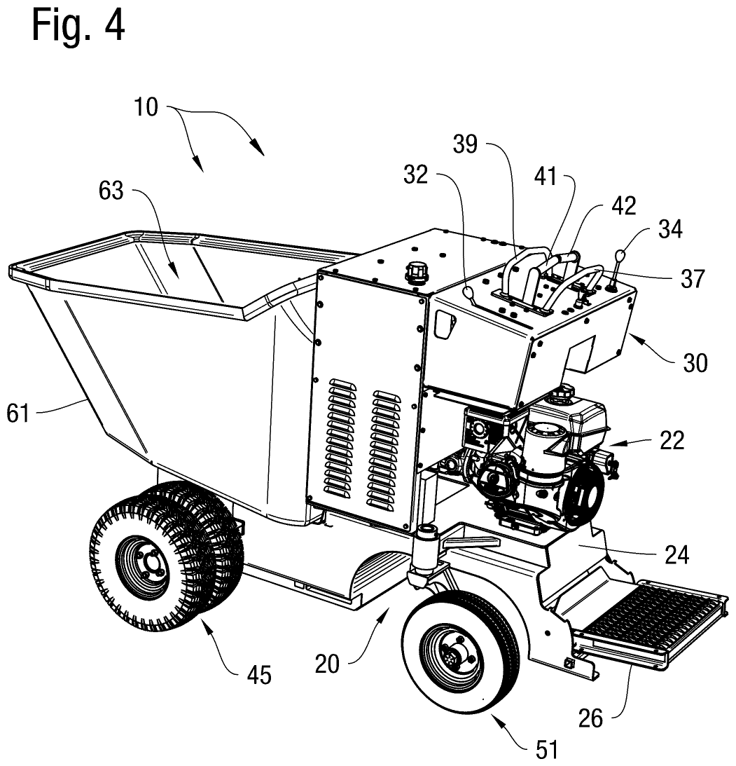

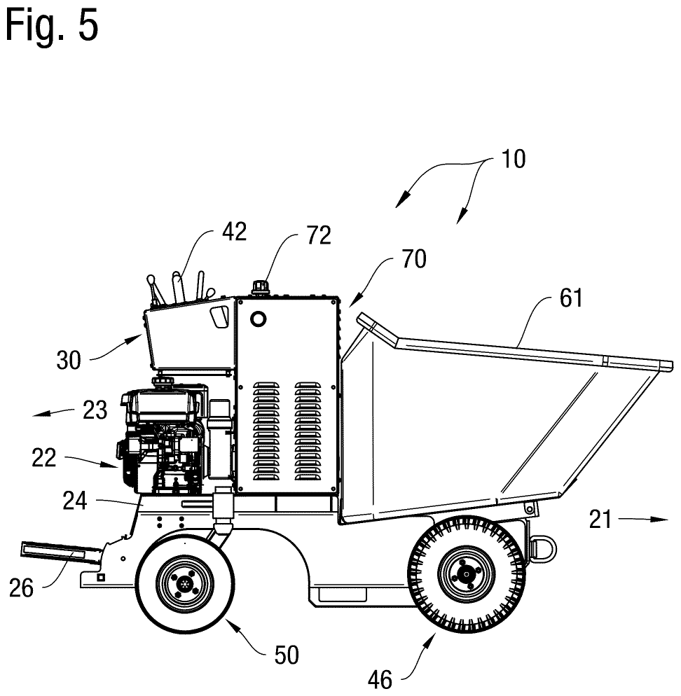

Cart 10 comprises a rigid chassis 20 having a front 21 and a rear 23 (FIG. 5). The vehicle chassis supports a rear-mounted, internal combustion motor 22 (FIG. 2), that is supported upon a rigid shelf 24 secured to the chassis. An adjacent, rear work platform 26 provides a support on which an operator or driver (not shown) may stand during cart operation. With an operator disposed on platform 26, the upper control console 30 will be easily accessible. The control console 30 mounts a hydraulic brake lever 32 at the left, and a dumping lever 34 at the right side (i.e., FIG. 4). A pair of upper grasping handles 37 and 39 projecting above the console 30 establish gripping supports that an operator can use to properly position himself or herself. A pair of upwardly projecting drive control handles 41 and 42 can be separately manipulated to control cart speed and drive wheel direction. Cart drive wheel assemblies 45, 46 will move forward when handles 41 and 42 are pushed forwardly, or they may be reversed by pulling handles 41, 42 rearwardly concurrently. However, when one handle of the handles 41, 42 is pushed forwardly, and concurrently the other of the handles is pulled rearwardly, quick and precise zero-turn radius steering movements will result, as the cartwheels 45, 46 revolve in opposite directions facilitating extreme turns.

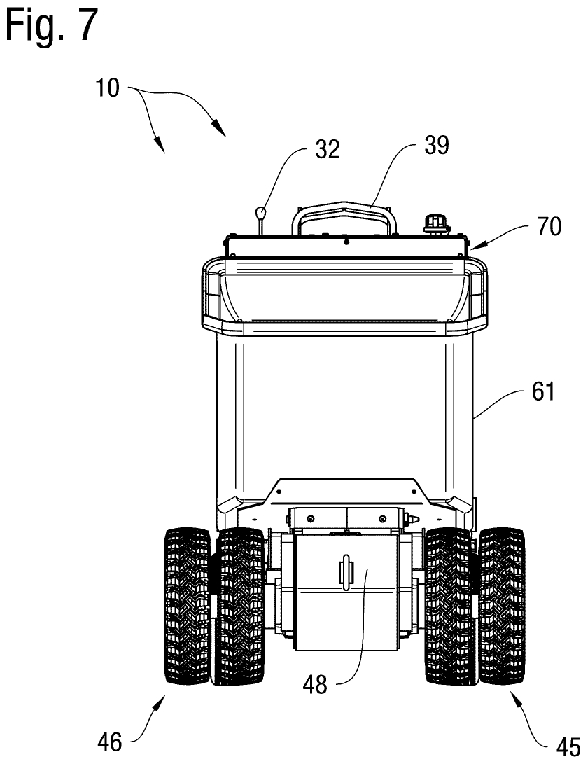

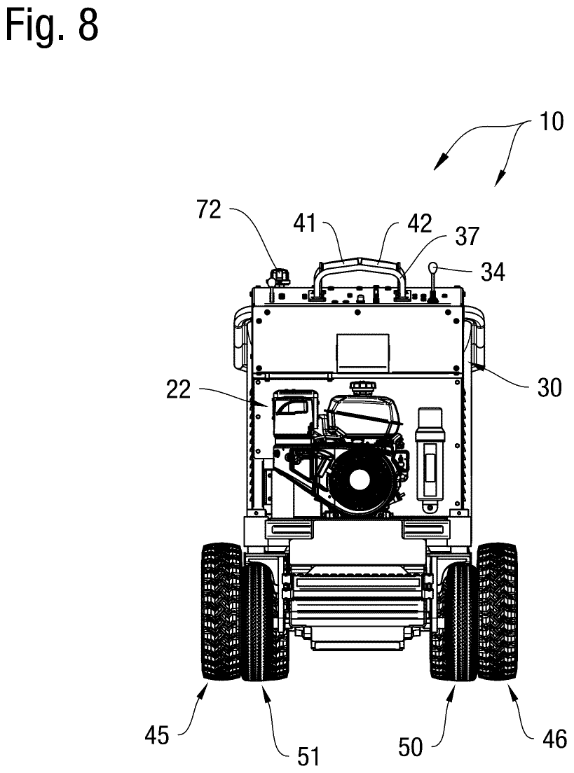

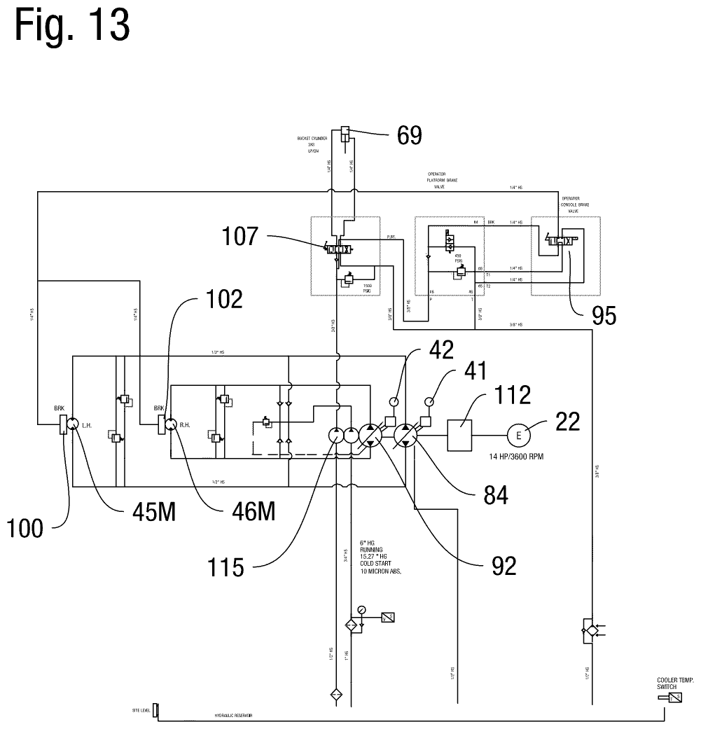

The dual drive wheel pairs 45 and 46 are mounted towards the front of the cart 10. Axle shafts (not shown) extend from and through conventional hydraulic drive motors 45M and 46M (FIG. 13) that are mounted within the drive compartment 48 (FIG. 7) at the front bottom of the chassis 20. Cart support is further provided by a pair of steerable non-driven caster wheel assemblies 50 (FIGS. 1, 8) and 51 (FIGS. 4, 8) that are preferably disposed on opposite sides of the cart 10 towards the cart rear.

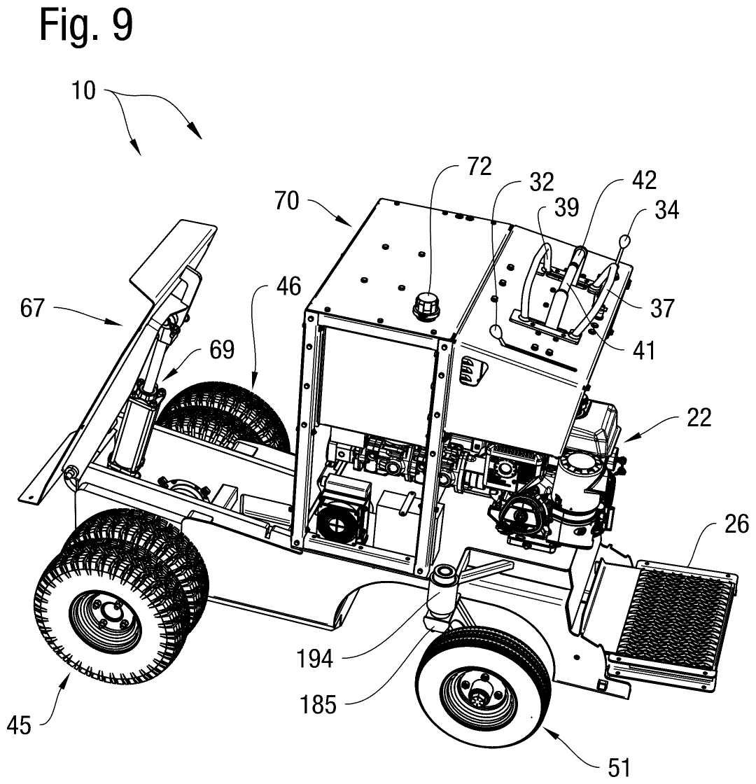

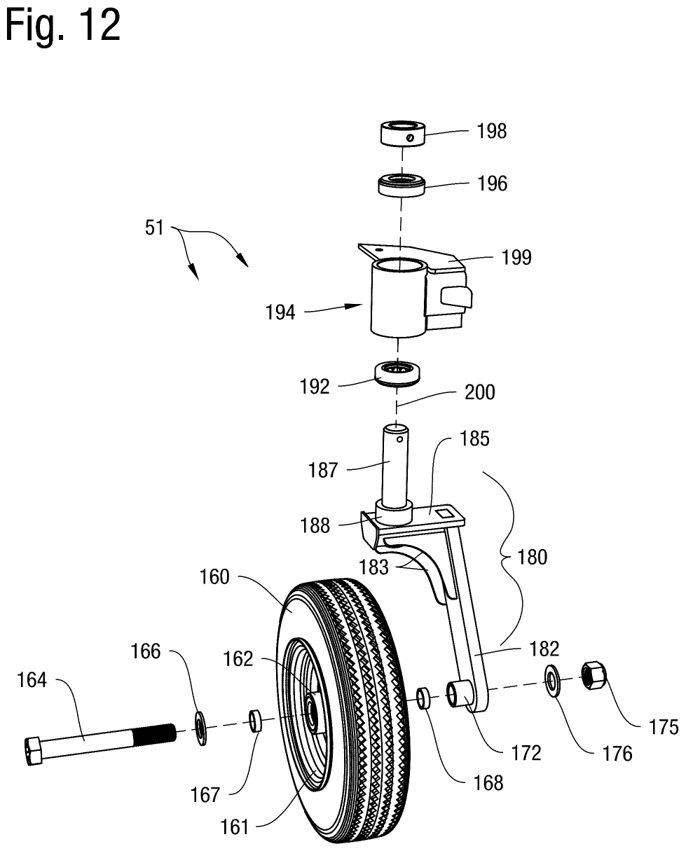

Chassis 20 also supports a hopper 61, in the preferred embodiment functioning as a concrete cargo bucket, that is tiltable over the front drive wheel pairs 45 and 46 for conveniently dumping cargo from bucket hopper interior 63. Hopper 61, which may take on a variety of shapes and configurations for different loads, is normally disposed in a seated, generally horizontal orientation for transport or loading as in FIGS. 1-6, but it can be hydraulically tilted for material discharge. Hopper 61 is mounted upon a hydraulically deflectable support bracket 67 (FIG. 9) that is controlled by a hydraulic cylinder 69 (FIG. 9). There are a pair of conventional hydraulic drive motors 45M and 46M (i.e., schematically shown in FIG. 12) within drive compartment 48 for driving the front dual wheel assemblies 45 and 46. Hydraulic fluid is stored within a suitable tank disposed within hydraulic storage cabinet 70, that can be filled through capped spigot 72 (i.e., FIG. 9).

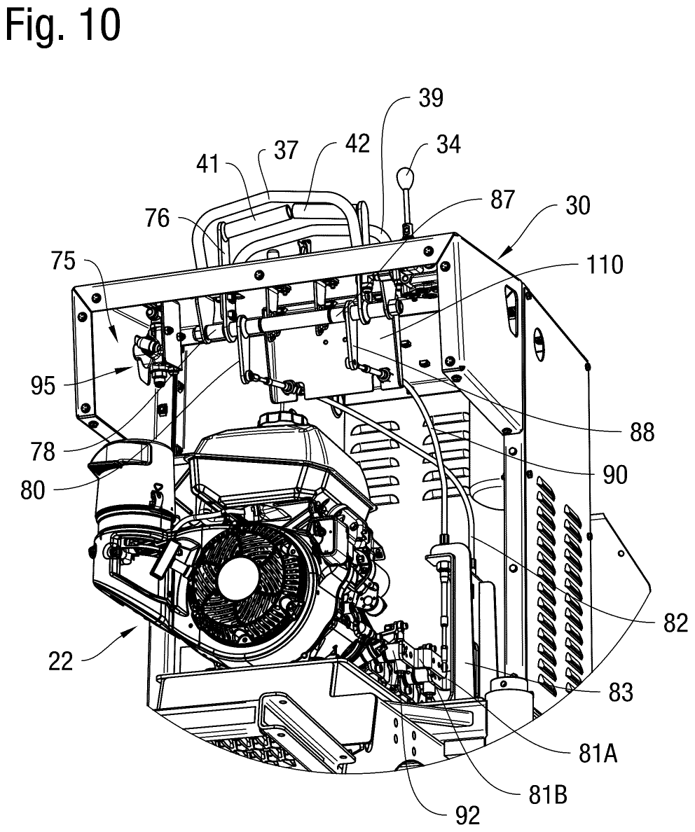

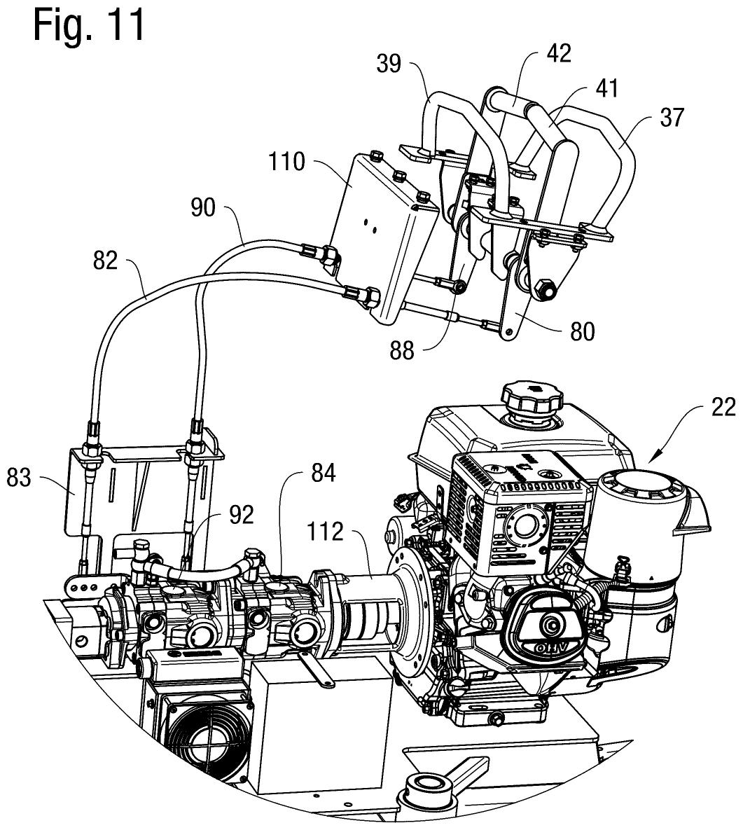

Referencing FIG. 10, the interior 75 of the control console houses and/or mounts a plurality of levers, linkages and control sleeves. Control handle 41 atop console 30 has a downwardly extending arm portion 76 that rotates a lower, transverse sleeve 78 in response to movement of the handle 41. Sleeve rotation revolves a lever 80 that actuates a cable 82 that leads to a termination bracket 83 and activates a link 81A (FIG. 10) that controls wheels 45 through hydraulic valve 84 (FIG. 13). Similarly, handle 42 can be pushed or pulled to rotate a sleeve 87, turning a lever 88 that activates cable 90 that ends in termination bracket 83 (FIGS. 10, 11) to adjust hydraulic valve 92 via lever 81B (FIGS. 10, 13) for wheels 46. Bucket or hopper control lever 34 at the top of console 30 operates a hydraulic valve 107 (FIGS. 10, 13) that activates bucket cylinder 69 (FIGS. 9, 13) to raise or lower hopper 61. The console-mounted hydraulic brake lever 32 (FIG. 9) operates with an interior hydraulic valve 95 that activates brakes 100 and 102 shown schematically in FIG. 13.

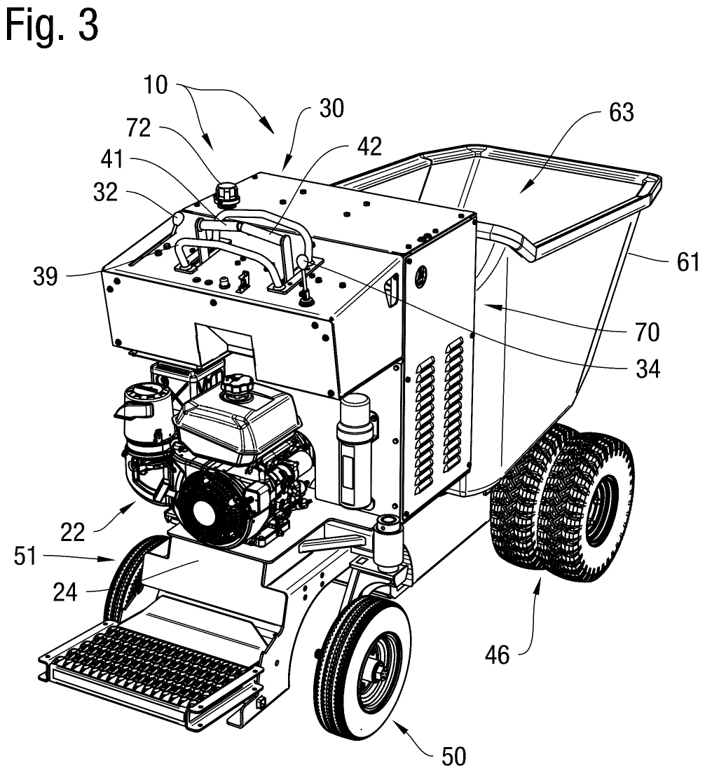

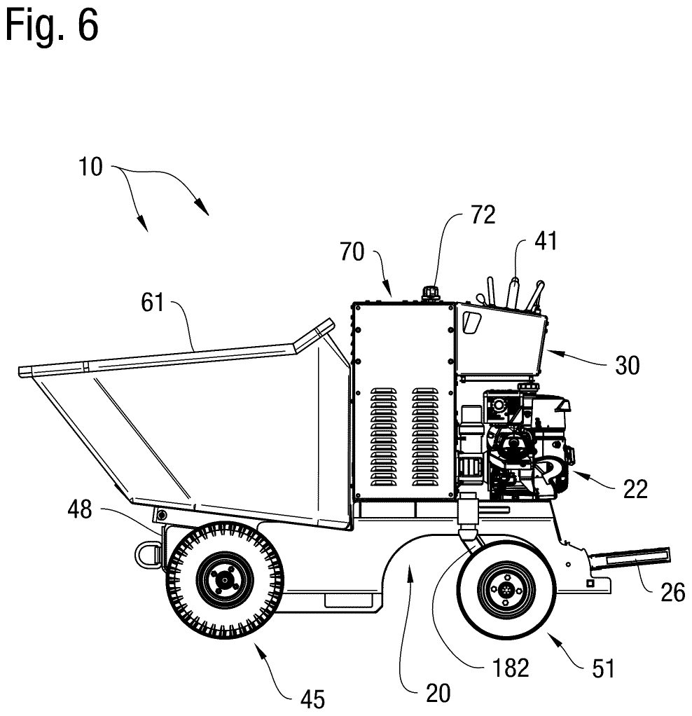

In FIG. 11 it is seen that the cables 82 and 90 extending from levers 80 and 88 traverse an isolation bracket 110 that is secured within control console 30 for cable securement. Similar bracing or anchoring is facilitated by cable bracket 83. Valve 84 controls the output of hydraulic pump 84 (FIGS. 11, 13) and valve 92 controls the output of hydraulic pump 92. As best seen in FIG. 11, internal combustion motor 22 outputs through a splined coupler 112 to drive hydraulic pumps 84 and 92 and an auxiliary pump 115 (FIG. 13) that controls bucket cylinder 69. The latter components are housed within compartment 70 (FIGS. 3, 6).

FIG. 12 details a preferred caster wheel assembly 51 that enables steering. Since opposite caster wheel assembly 50 is a mirror image of assembly 51, only one will be described in detail. Caster wheel assembly 51 comprises a tire 160 mounted upon a wheel 161 whose bearing hub housing 162 is penetrated by a through bolt 164 that functions as an axle. Bolt 164 penetrates a washer 166, a first bearing 167, hub housing 162, a second bearing 168, and a hollow sleeve 172, before being secured with a terminal nut 175 and a washer 176. The lower part of strut 180 mounts the sleeve 172. Strut 180 comprises an angled caster bar 182 whose upper end is reinforced with a pair of spaced-apart gussets 183. Caster bar 182 secures and supports pintle platform 185 that mounts a rigid, tubular pintle 187 that is coaxial with a rigid top collar 188. Pintle 187 penetrates a lower bearing 192 before coaxially penetrating gudgeon 194 and upper bearing 196, being terminated by a bearing cap 198. Gudgeon 194 comprises a rigid, horizontal mounting portion 199 that is secured under cart 10 by attachment to the chassis 20. Bar 182 establishes negative caster for the wheel 161. The caster-wheel function establishes the zero turn radius function and feature of the cart 10.

Pintle 187 is colinear with the longitudinal axis 200 of the caster wheel assembly 51. Pintle 187 and axis 200 are vertically oriented. Caster bar 182 projects downwardly and rearwardly from platform 185. Thus, when the cart 10 is disposed upon a flat, level surface, the wheel 161 (and tire 160) exhibit negative caster and zero camber.

From the foregoing, it will be seen that this invention is one well adapted to obtain all the ends and objects herein set forth, together with other advantages which are inherent to the structure.

It will be understood that certain features and subcombinations are of utility and may be employed without reference to other features and subcombinations.

As many possible embodiments may be made of the invention without departing from the scope thereof, it is to be understood that all matter herein set forth or shown in the accompanying drawings is to be interpreted as illustrative and not in a limiting sense.

What is claimed is:

1. A self-propelled “zero turn radius” batch cart for delivering loads of materials such as raw concrete mix to construction job sites, the cart comprising:
a rigid chassis adapted to be disposed proximate a job site, the chassis having a front and a rear;
a tiltable cargo bucket mounted on the front of said chassis, the cargo bucket adapted to be switched between material transport and material discharge positions;
a pair of drive wheel assemblies secured at the front of said chassis for cart propulsion and maneuvering;
at least one caster wheel secured at the rear of the chassis;
drive motors for rotating said wheel assemblies, said drive motors operable independently of one another so that one of said pair of drive wheel assemblies may be reversed in rotation relative to the other pair of drive wheel assemblies;
wherein said at least one caster wheel is mounted with negative caster; and,
whereby extreme “zero turn” cart maneuvering may be established with the drive wheel assemblies in cooperation with said at least one caster wheel.

2. A self-propelled “zero turn radius” batch cart for delivering loads of materials such as raw concrete mix to otherwise hard-to-reach construction job sites, the cart comprising:
rigid chassis adapted to be disposed proximate the job site and moved over it;
a tiltable bucket supported by said chassis and adapted to be hydraulically switched between transport and discharge positions;
a pair of front-mounted hydraulic drive wheel assemblies secured to said chassis for propulsion and maneuvering;
at least one rear caster wheel secured to said chassis, said at least one caster wheel mounted with negative caster;
hydraulic drive motors for powering said drive wheel assemblies;
wherein said drive wheel assemblies may be rotated in either the same or different directions independently of one another; and,
wherein extreme “zero turn” cart maneuvering may be established with the drive wheel assemblies in cooperation with said at least one caster wheel.
